(19) United States
(12) Patent Application Publication
(10) Pub. No.: US 2009/0213026 A1
(43) Pub. Date: Aug. 27, 2009

(54) ANTENNA ARRANGEMENT PROVIDED WITH A WAVE TRAP

(75) Inventors: Peter Lindberg, Uppsala (SE); Erik Öjefors, Wuppertal (DE)

Correspondence Address: HOLLAND & HART, LLP, P.O BOX 8749, DENVER, CO, 80201, US

(73) Assignee: Laird Technologies AB

(21) Appl. No.: 12/089,417

(22) PCT Filed: Oct. 5, 2006
(86) PCT No.: PCT/SE06/01133

§ 371 Date: Sep. 16, 2008

(30) Foreign Application Priority Data
Oct. 10, 2005 (SE) 0502225-6

(51) Int. Cl. H01Q 1/48; H01Q 1/38

(52) U.S. Cl. 343/848; 343/700 MS

(57) ABSTRACT

The present invention related to an antenna arrangement comprising at least a first antenna element and a ground plane means, wherein the antenna arrangement is provided at a first end of the ground plane means. The invention is characterised in that a wave trap is provided at a second end of the ground plane means, and the second end is located opposite to the first end.

### TECHNICAL FIELD

The present invention relates to an antenna arrangement for sending and receiving RF-signals. The present invention relates more specifically to an antenna arrangement for sending and receiving RF-signals having increased bandwidth in at least one higher frequency band.

### BACKGROUND OF THE INVENTION

There is a constant drive in the art of improving bandwidth characteristics of antenna arrangements for use in mobile communication devices. This has commonly been achieved with the use of differently shaped antenna elements, parasitic elements and different positioning of the antenna elements in relation to each other and to the ground plane.

Common cellular devices use several different frequency bands for communication within different standardized communication protocols, such as GSM, DCS, DAMPS etc. It is now commonplace to design mobile phones that are capable to operate in no less than three different frequency bands such as GSM 800, GSM 900 and DCS 1900. Increased bandwidths for all of these frequencies are always desirable.

### SUMMARY OF THE INVENTION

The bandwidth of an antenna arrangement varies with the length of the ground plane means. A common length for the ground plane means in modern cellular phones is around 100 mm. This length is set by a number of factors. These factors include, a comfortable length for handling the mobile device, i.e. the mobile device should sit well in the palm of a user, having enough room for electronic components in the mobile device, etc.

Unfortunately the bandwidth for the frequency band 2 GHz has a minimum for a length of approximately 100 mm of the ground plane means as is shown in FIG. 1.

By providing the ground plane means with wave traps at an opposite end of the antenna means the electrical length of the ground plane means as perceived by the antenna means can be adjusted to thereby increase the bandwidth of the antenna arrangement.

It is a main object of the present invention to provide such apparatus that at least alleviate the above problems.

It is in this respect a particular object of the invention to provide such apparatus that provides greater bandwidth to a mobile communication device.

These objects among others are, according to one aspect of the present invention, attained by an antenna arrangement comprising at least a first antenna element and a ground plane means wherein the antenna arrangement is provided at a first end of the ground plane means. The invention is characterised in that a wave trap is provided at the ground plane means.

According to one variant of the invention the wave trap is provided at a specified distance from a second end of said ground plane means wherein the second end is located opposite to the first end of the ground plane means.

The wave trap, positioned at an opposite end to the antenna radiating means, and connected to the ground plane, will shorten the electrical length of the ground plane means so that the electrical length of the ground plane means, as perceived by the antenna radiating means, is not equal to a minimum in the relationship between bandwidth and the length of the ground plane means for some specified frequency. Thus, the bandwidth is increased.

According to one variant of the present invention the antenna element is a PIFA-antenna provided above the ground plane means.

According to another variant of the invention the wave trap comprises a first conductor electrically connected to the second end and extending in a general direction towards the first end.

According to one variant of the present invention the antenna element is a PIFA-antenna provided to send and receive RF-signals in at least two different frequency bands.

According to another variant of the invention the wave trap comprises a first and a second conductor electrically connected to the second end and extending in a general direction towards the first end, and wherein the first and second conductor are located on opposite sides of the ground plane means.

According to another variant of the present invention the first and/or second conductor is a quarter of the wavelength of one frequency for which the antenna arrangement is provided to send and receive RF-signals. By this arrangement the wave traps will “cut-off” the ground plane for the design frequency, that is the frequency for which the conductors has a quarter wavelength, at the position of the tips of the conductors. By suitable positioning of the conductors the electrical length of the ground plane for the design frequency can be selected to optimise the bandwidth, or at least avoid bandwidth minima due to the specific length of the ground plane.

According to another variant of the invention the ground plane means has a substantially flat, rectangular shape, wherein the long side of the rectangle is 70 to 130 mm long, preferably 80 to 120 mm long, or 90 to 110 mm long, and more preferably approximately 100 mm long.

According to another variant of the invention the antenna arrangement is provided to send and receive RF-signals at least in the frequency band 1700 MHz to 2300 MHz, preferably 1800 MHz to 2000 MHZ, and more preferably in approximately 1800 MHZ and 1900 MHz.

According to one variant of the invention the first and second conductor are conductive wirings.

According to one variant of the present invention the first and second conductor are provided by providing first and second L-shaped cut-outs in the ground plane.

Further characteristics of the invention and advantages thereof will be evident from the following detailed description of embodiments of the invention.

### BRIEF DESCRIPTION OF THE DRAWINGS

The present invention will become more fully understood from the detailed description of embodiments of the present invention given herein below and the accompanying FIGS. 1 to 6, which are given by way of illustration only, and thus are not limitative of the present invention.

FIG. 1a is a schematic plot of the relation between the bandwidth and the length of the ground plane means for the 900 and 1800 MHz band.

FIG. 1b is a schematic plot of the relation between the bandwidth and the length of the ground plane means for the 2000 MHz band using a PIFA.

FIG. 2a is a schematic top view of one variant according to the present invention.

FIG. 2b is a schematic side view of the variant of the invention shown in FIG. 2a.

FIG. 3a is a schematic top view of another variant according to the present invention.

FIG. 3b is a schematic side view of the variant of the invention shown in FIG. 3a.

FIG. 4a is a measured plot comparing a dual band antenna arrangement according to the present invention having a wave trap with a traditional antenna arrangement without a wave trap.

FIG. 4b is a simulated plot comparing a dual band antenna arrangement according to the present invention having a wave trap with a traditional antenna arrangement without a wave trap.

FIG. 5 is a schematic top view of three different configurations of the position of the wave trap according to the present invention.

FIG. 6 is a simulated plot comparing a single band antenna arrangement in the 2 GHz band according to the present invention having a wave trap with a traditional antenna arrangement without a wave trap.

### PREFERRED EMBODIMENTS

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

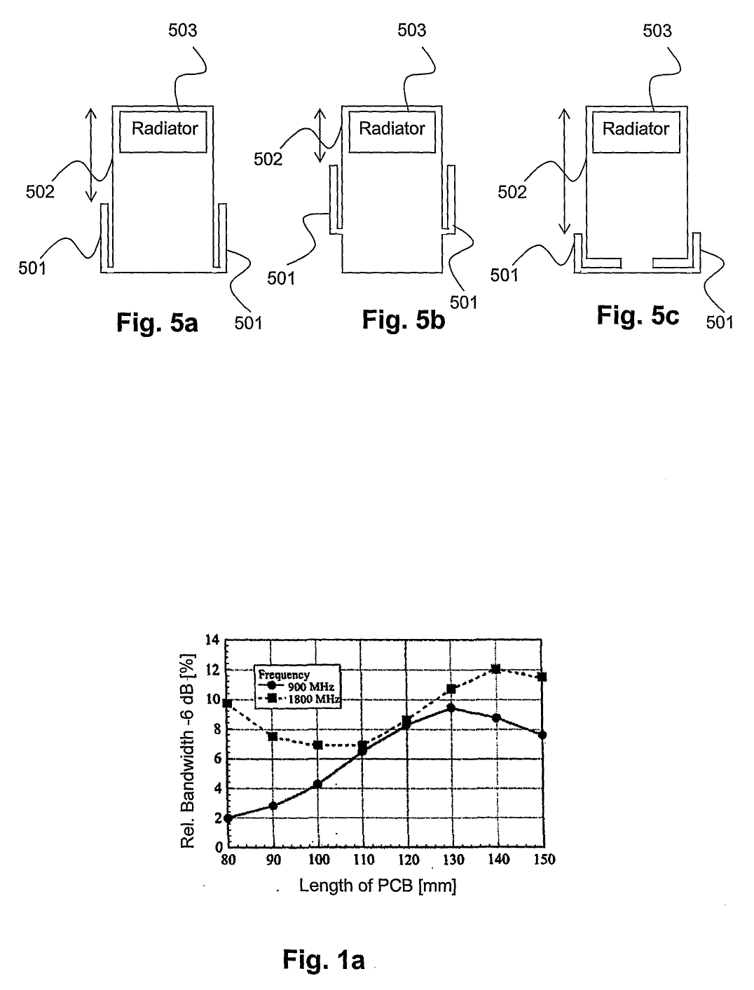

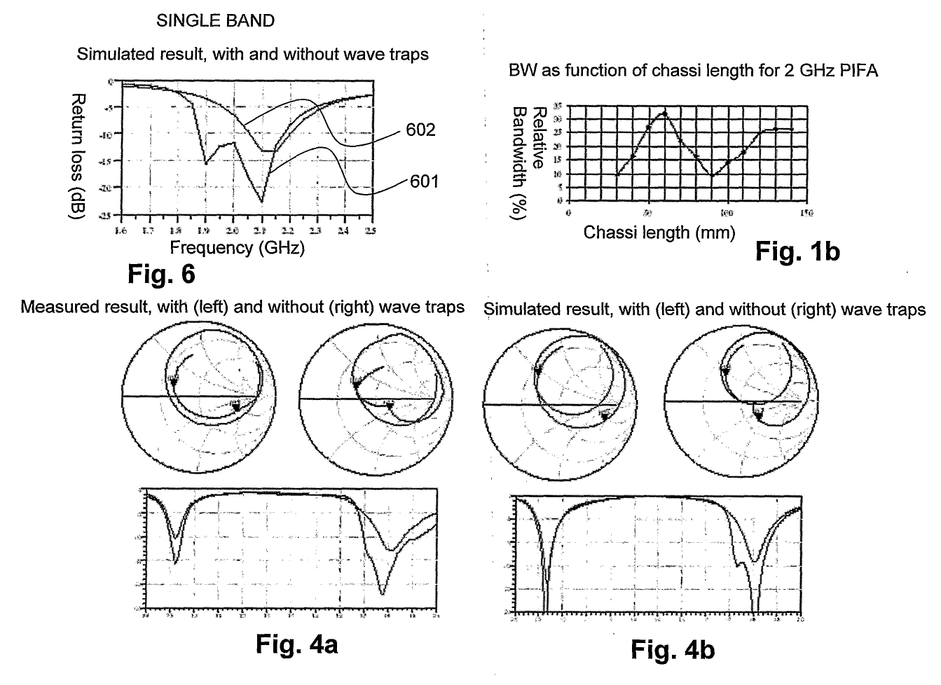

FIGS. 1a and 1b are schematic plots showing how the bandwidth varies with the length of the ground plane means for the 900 MHz band and 1800 MHz band in FIG. 1a and 2000 MHz band in FIG. 1b. As can easily be seen in the figures the bandwidth has a minimum for some specific lengths of the ground plane means depending on the design frequency. For the frequency 2 GHz, roughly corresponding to the new third generation standards, this length is approximately 100 mm. Unfortunately, this is also a common length of mobile communication devices, and thereby of the ground plane experienced by the radiating devices, i.e. antennas, provided for receiving and transmitting RF-signals in the frequency bands close to 2 GHz.

Thus, it would be beneficial, for radio signalling purposes, if the ground plane could be shortened or extended to not coincide with the bandwidth minimum. However, in mobile communication devices, integration has come very far and every square millimeter is oftentimes occupied with electronics. Therefore, it is not feasible to extend or shorten the factual length of the ground plane.

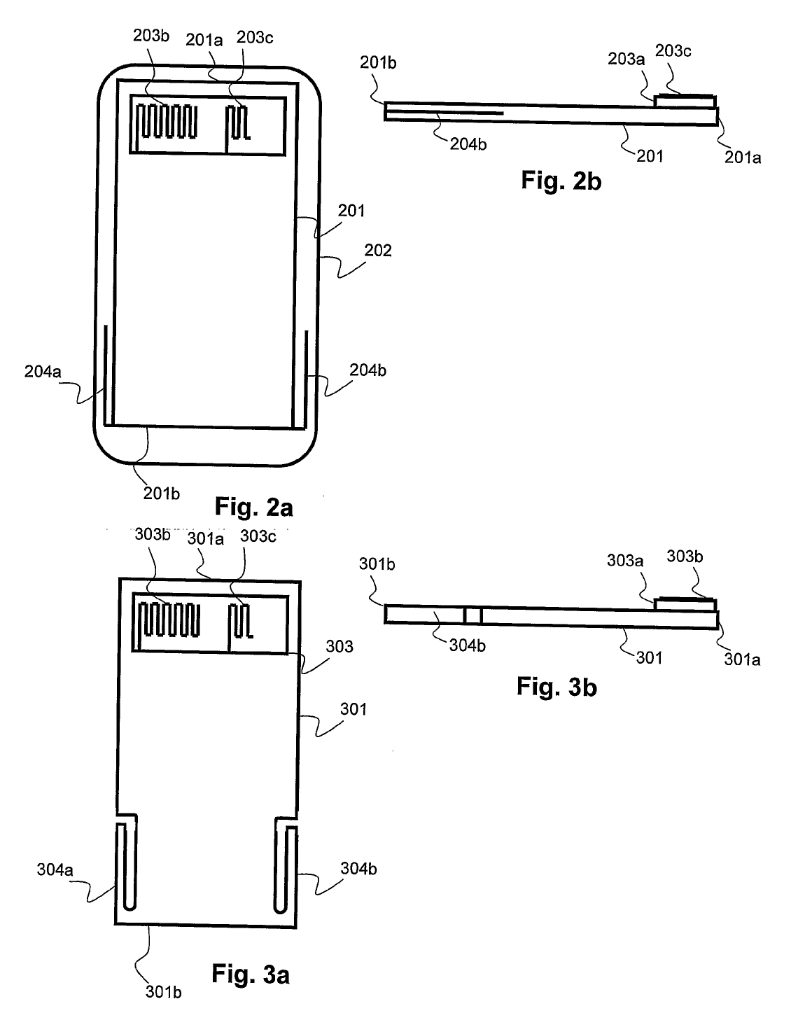

FIG. 2a is a schematic top view of one variant of the present invention. A ground plane means 201 is provided in a mobile communication device 202. The ground plane means 201 are most often provided as a part of a printed circuit board (not shown), but may also be provided by other means.

FIG. 2b is a schematic side view of the arrangement disclosed in FIG. 2a. Same details are in FIG. 2b denoted with same numerals as in FIG. 2a.

As can be seen in FIGS. 2a and 2b the ground plane means 201 has a substantially plane, rectangular shape with an antenna means, comprising a dielectric part 203a and radiating elements 203b and 203c provided at a first end 201a of the ground plane means 201. The radiating elements 203b and 203c are tuned to the 800 MHz and 2000 MHz frequency bands, respectively. The antenna means may be provided completely over, partially over or at the side of the ground plane means 201. Furthermore, the antenna means may be a PIFA, IFA, L-antenna, half-loop, monopole, or any other antenna means which induces radiating currents in the ground plane.

At an opposite end 201b to the first end 201a are first and second conductive wires 204a and 204b provided. The conductive wires 204a and 204b extends a short bit out from, or orthogonally to the ground plane means, is bent 90 degrees and extends further, at the side of the ground plane means 201, in the direction towards the first end 201a. The length of the conductive wires 204a and 204b are approximately a quarter of the wavelength of 2 GHz, that is, approximately 3.75 cm for vacuum. If the space between the conductive wires and the ground plane is filled with a dielectric the length may be shortened. This may affect the electrical impedance, but then again this may be corrected by adjusting the spacing between the conductive wires and the ground plane.

The conductive wires 204a and 204b may conveniently be provided in the housing of the mobile device or at any other convenient place. The space between the conductive wires 204a and 204b and the ground plane means 201 may be filled with a suitable dielectric material for further tuning of the bandwidth.

FIG. 3a is a schematic top view of another variant of the invention showing a ground plane means 301. FIG. 3b is a schematic side view of the arrangement according to FIG. 3a. An antenna means 303, comprising a dielectric part 303a and radiating antenna means 303b and 303c, is provided at a first end 301a of the ground plane means 301. The radiating means 303b and 303c are tuned to the 800 MHz band and 2000 MHz band, respectively.

First and second conducting means 304a and 304b are provided at a second end 301b, opposite to the first end 301a, of the ground plane means 301. The conducting means 304a and 304b are provided by providing a cut-out in the ground plane means 301. The cut-out is L shaped as is seen in FIG. 3a.

The length of the wave traps should be a quarter wavelength of the design frequency, for instance for 2 GHz the length will be approximately 3.75 cm. The positioning of the wave traps at the side of the ground plane means is depending on the specific design of the radiating structure, the design of the ground plane means, circuitry located in the PCB, the design of the handset etc. One simple procedure to decide the best positioning could be by try and error. That is, to try out different positions and measure the achieved bandwidth in an experiment environment. Alternatively, simulation may be used.

FIGS. 5a to 5c are schematic top views of three different positions for the wave traps. As can be seen in FIG. 5 the wave traps 501 may be positioned at different positions along the side of the ground plane means 502 so that the ground plane means may extend below the connection between the wave trap and the ground plane means. In FIG. 5a the wave traps 501 are coupled to the ground plane means 502 at the opposite end of the ground plane means in relation to the position of the radiating element 503. In FIG. 5b the wave traps 501 are coupled to the ground plane means at a specified distance from the radiator 503. The ground plane means 502 thus extends below the connection with the wave traps 501. In FIG. 5c the wave traps 501 are connected to the ground plane means 502 at the end. The wave traps extends for a apart along the end portion of the ground plane means and then further along the side of the ground plane means. This make it possible to have quarter wavelength wave traps which extends shorter than a quarter wavelength along the side of the ground plane means.

FIG. 4a and FIG. 4b are a measured and a simulated plot, respectively, of an antenna arrangement according to the present invention having wave traps compared to antenna arrangements without wave traps. As can be seen from the plots a considerable increase in bandwidth is achieved using the wave trap according to the invention.

FIG. 6 is a schematic plot of a simulated result comparing the bandwidth of a single band antenna arrangement having a wave trap 601 with a single band antenna arrangement without a wave trap 602 for the 2 GHz band. As is clearly seen the bandwidth is increased with the use of wave traps according to the invention.

It should be mentioned that currents will still flow in the ground plane means below the open ends of the wave traps. There will be a current minimum at the open ends of the wave traps and current maxima at the connection between the wave traps and the ground plane means. The currents in the ground plane below the open ends will however be in differential mode in relation to the currents in the wave traps and will therefore not radiate.

It will be obvious that the invention may be varied in a plurality of ways. Such variations are not to be regarded as a departure from the scope of the invention. All such modifications as would be obvious to one skilled in the art are intended to be included within the scope of the appended claims.

1. Antenna arrangement comprising at least a first antenna element and a ground plane means, and said antenna arrangement is provided at a first end of said ground plane means characterised in that
a wave trap is provided on said ground plane means.

2. The antenna arrangement according to claim 1, wherein said wave trap is provided at a specified distance from a second end of said ground plane means, and
said second end is located opposite to said first end of said ground plane means.

3. The antenna arrangement according to claim 2, wherein said specified distance is selected so that said antenna arrangement has an increased bandwidth compared to a similar antenna arrangement having no wave traps.

4. Antenna arrangement according to claim 1, wherein
said antenna element is a PIFA-antenna provided above said ground plane means.

5. Antenna arrangement according to claim 1, wherein
said ground plane means has a substantially rectangular shape.

6. Antenna arrangement according to claim 2, wherein
said wave trap comprises a first conductor electrically connected to said second end and extending in a general direction towards said first end.

7. Antenna arrangement according to claim 1, wherein
said antenna element is a PIFA-antenna provided to send and receive RF-signals in at least two different frequency bands.

8. Antenna arrangement according to claim 6, wherein said first conductor is a quarter of the wavelength of the highest frequency band for which the antenna arrangement is provided to send and receive RF-signals.

9. Antenna arrangement according to claim 6, wherein said wave trap comprises a second conductor electrically connected to said second end and extending in a general direction towards said first end, and said first and second conductor are located on opposite sides of said ground plane means.

10. Antenna arrangement according to claim 1, wherein
said ground plane means has a substantially flat, rectangular shape, wherein the long side of said rectangle is 70 to 130 mm long, preferably 80 to 120 mm long, or 90 to 110 mm long, and more preferably approximately 100 mm long.

11. Antenna arrangement according to claim 1, wherein
said antenna arrangement is provided to send and receive RF-signals at least in the frequency band 1700 MHz to 2300 Mhz, preferably 1800 MHz to 2000 MHz, and more preferably in approximately 1800 MHZ and 1900 MHz.

12. Antenna arrangement according to claim 9, wherein said first and second conductor are conductive wirings.

13. Antenna arrangement according to claim 9, wherein said first and second conductor are provided by providing first and second L-shaped cut-outs in said ground plane.
